(19) United States
(12) Patent Application Publication
(10) Pub. No.: US 2019/0325293 A1
(43) Pub. Date: Oct. 24, 2019

(54) TREE ENHANCED EMBEDDING MODEL PREDICTIVE ANALYSIS METHODS AND SYSTEMS

(71) Applicant: National University of Singapore, Singapore (SG)

(72) Inventors: Xiang WANG, Singapore (SG); Xiangnan HE, Singapore (SG); Fuli FENG, Singapore (SG); Tat-Seng CHUA, Singapore (SG)

(21) Appl. No.: 16/388,624

(22) Filed: Apr. 18, 2019

(30) Foreign Application Priority Data
Apr. 19, 2018 (SG) 10201803291Q

(51) Int. Cl. G06N 3/04; G06K 9/62; G06F 16/901

(52) U.S. Cl. CPC G06N 3/0472; G06F 16/9027; G06K 9/6256

(57) ABSTRACT

Methods and systems for predictive analysis are disclosed. A predictive analysis method comprises receiving input data comprising an indication of a user, an indication of an item, a user feature vector indicating features of the user and an item feature vector indicating features of the item; and constructing a cross feature vector indicating values for cross features between features of the user and features of the user. Embedding vectors derived from the cross feature vector, the user feature vector and the item feature vector are input into an attention network to determine a set of attentive weights which indicate cross features between the user and item features. These cross features are used in the identification of a user item preference.

### CROSS-REFERENCE TO RELATED APPLICATIONS

The present application claims priority to Singapore Application No. SG 10201803291Q filed with the Intellectual Property Office of Singapore on Apr. 19, 2018, which is incorporated herein by reference in its entirety for all purposes.

### TECHNICAL FIELD

The present disclosure relates to predictive analysis using machine learning and more specifically to an embedding model used in predictive analysis.

### BACKGROUND

Personalized recommendation is at the core of many online customer-oriented services, such as e-commerce, social media, and content-sharing websites. Technically speaking, the recommendation problem is usually tackled as a matching problem, which aims to estimate the relevance score between a user and an item based on their available profiles. Regardless of the application domain, a user's profile usually consists of an ID (to identify which specific user) and some additional information like age, gender, and income level. Similarly, an item's profile typically contains an ID and some attributes like category, tags, and price.

Collaborative filtering (CF) is the most prevalent technique for building a personalized recommendation system. CF leverages users' interaction histories on items to select the relevant items for a user. From the matching view, CF uses the ID information only as the profile for a user and an item, and forgoes other additional information. As such, CF can serve as a generic solution for recommendation without requiring any domain knowledge. However, the downside is that it lacks necessary reasoning or explanations for a recommendation. Specially, the explanation mechanisms are either because your friend also likes it (i.e., user-based CF) or because the item is similar to what you liked before (i.e., item-based CF), which are too coarse-grained and may be insufficient to convince users on a recommendation.

To persuade users to perform actions on a recommendation, we believe it is crucial to provide more concrete reasons in addition to similar users or items. For example, we recommend iPhone 7 Rose Gold to user Emine, because we find females aged 20-25 with a monthly income over $10,000 (which are Emine demographics) generally prefer Apple products of pink color. To supercharge a recommender system with such informative reasons, the underlying recommender shall be able to (i) explicitly discover effective cross features from the rich side information of users and items, and (ii) estimate user-item matching score in an explainable way. In addition, we expect the use of side information will help in improving the performance of recommendation.

Nevertheless, none of existing recommendation methods can satisfy the above two conditions together. In the literature, embedding-based methods such as matrix factorization is the most popular CF approach, owing to the strong power of embeddings in generalizing from sparse user-item relations. Many variants have been proposed to incorporate side information, such as factorization machine (FM), Neural FM, Wide&Deep, and Deep Crossing. While these methods can learn feature interactions from raw data, cross feature effects are only captured in a rather implicit way during the learning process; and most importantly, the cross features cannot be explicitly presented. Moreover, existing works on using side information have mainly focused on the cold-start issue, leaving the explanation of recommendation relatively less touched.

### SUMMARY OF THE INVENTION

According to a first aspect of the present disclosure a predictive analysis method comprises: receiving input data comprising an indication of a user, an indication of an item, a user feature vector indicating features of the user and an item feature vector indicating features of the item; constructing a cross feature vector indicating values for cross features between features of the user and features of the user; projecting each cross feature of the cross feature vector onto an embedding vector to obtain a set of cross feature embedding vectors; projecting the user feature vector onto the embedding vector to obtain a user feature embedding vector and projecting the item feature vector onto the embedding vector to obtain an item feature embedding vector; inputting the cross feature embedding vectors, the user feature embedding vector and the item feature embedding vector into an attention network to determine a set of attentive weights, the set of attentive weights comprising an attentive weight for each cross feature of the cross feature vector; performing a pooling operation over the set of attentive weights to obtain a unified representation of cross features; concatenating an elementwise product of the user embedding vector and the item embedding vector with the unified representation of cross features to obtain a concatenated vector; projecting the concatenated vector to obtain a prediction of a user item preference; and outputting an indication of the user item preference.

In an embodiment, the method further comprises outputting an indication of at east one attentive weight of the set of attentive weights.

In an embodiment, the method further comprises receiving an input indicating an adjustment to the set of attentive weights and adjusting attentive weights of the set of attentive weights in accordance with the adjustment.

In an embodiment, constructing a cross feature vector comprises using a gradient boosting decision tree.

In an embodiment, the cross feature vector is a sparse vector.

In an embodiment, the pooling operation is an average pooling operation.

In an embodiment, the pooling operation is a max pooling operation.

In an embodiment, the attentive network is a multilayer perceptron.

According to a second aspect of the present disclosure, a data processing system comprises a processor and a data storage device. The data storage device stores computer executable instructions operable by the processor to: receive input data comprising an indication of a user, an indication of an item, a user feature vector indicating features of the user and an item feature vector indicating features of the item; construct a cross feature vector indicating values for cross features between features of the user and features of the user; project each cross feature of the cross feature vector onto an embedding vector to obtain a set of cross feature embedding vectors; project the user feature vector onto the embedding vector to obtain a user feature embedding vector and project the item feature vector onto the embedding vector to obtain an item feature embedding vector; input the cross feature embedding vectors, the user feature embedding vector and the item feature embedding vector into an attention network to determine a set of attentive weights, the set of attentive weights comprising an attentive weight for each cross feature of the cross feature vector; perform a pooling operation over the set of attentive weights to obtain a unified representation of cross features; concatenate an elementwise product of the user embedding vector and the item embedding vector with the unified representation of cross features to obtain a concatenated vector; project the concatenated vector to obtain a prediction of a user item preference; and output an indication of the user item preference.

According to a yet further aspect, there is provided a non-transitory computer-readable medium. The computer-readable medium has stored thereon program instructions for causing at least one processor to perform operations of a method disclosed above.

### BRIEF DESCRIPTION OF THE DRAWINGS

In the following, embodiments of the present invention will be described as non-limiting examples with reference to the accompanying drawings in which:

FIG. 1 is a block diagram showing an illustrative architecture of a tree enhanced embedding model according to an embodiment of the present invention.

FIG. 2 is a block diagram showing a technical architecture of a data processing system according to an embodiment of the present invention;

FIG. 3 is a flowchart showing a method of predictive analysis using a tree enhanced embedding model according to an embodiment of the present invention;

FIG. 4A shows an example gradient boosting decision tree used in an embodiment of the present invention to generate a cross feature vector;

FIG. 4B is a table showing example user and item attributes corresponding to the gradient boosting decision tree shown in FIG. 4A;

FIG. 5 shows an example attention network used with embodiments of the present invention;

FIG. 6 is a flowchart showing a method of estimating the parameters of a predictive model according to an embodiment of the present invention;

FIG. 7 is a table showing two datasets used in example recommendation scenarios for embodiments of the present invention;

FIG. 8 is a table showing a performance comparison of the tree-enhanced embedding method of the present disclosure with other predictive analysis methods;

FIGS. 9A to 9D show performance comparisons of the tree enhanced embedding method of the present disclosure with other methods with and without cross feature modelling.

FIG. 10A and FIG. 10B show visualizations of cross feature attention produced by an embodiment of the present invention;

FIG. 10C is a table showing the descriptions of cross features shown in FIG. 10A and FIG. 10B; and

FIG. 11 shows an example of adjusting recommendation in an embodiment of the present invention.

### DETAILED DESCRIPTION

In the present disclosure, a recommendation solution that is both accurate and explainable is described. By accurate, we expect our method to achieve the same level of performance as existing embedding-based approaches. By explainable, we would like our method to be transparent in generating a recommendation and is capable of identifying the key cross features for a prediction. Towards this end, we propose a novel solution named Tree-enhanced Embedding Model (TEM), which combines embedding-based methods with decision tree-based approaches. First, we build a gradient boosting decision trees (GBDT) on the side information of users and items to derive effective cross features. We then feed the cross features into an embedding-based model, which is a carefully designed neural attention network that reweights the cross features according to the current prediction. Owing to the explicit cross features extracted by GBDTs and the easy-to-interpret attention network, the overall prediction process is fully transparent and self-explainable. Particularly, to generate reasons for a recommendation, we just need to select the most predictive cross features based on their attention scores.

As a main technical contribution, this disclosure presents a new scheme that unifies the strengths of embedding-based and tree-based methods for recommendation. Embedding-based methods are known to have strong generalization ability, especially in predicting the unseen crosses on user ID and item ID (i.e., capturing the CF effect). However, when operating on the rich side information, embedding-based methods lose the important property of explainability—the cross features that contribute most to the prediction cannot be revealed. On the other hand, tree-based methods predict by generating explicit decision rules, making the resultant cross features directly interpretable. While such a way is highly suitable for learning from side information, it fails to predict unseen cross features, thus being unsuitable for incorporating user ID and item ID. To build an explainable recommendation solution, we combine the strengths of embedding-based and tree-based methods in a natural and effective manner, which to our knowledge has never been studied before.

In this disclosure, we demonstrate the effectiveness and explainability of TEM in the recommendation scenarios. However, TEM, as an easy-to-interpret model, can be used in a wide bunch of applications like recommender systems (e.g., E-commerce recommendation), social networking services (e.g., friend recommendation or word-of-mouth marketing), and advertising services (e.g., audience detection, click-through rate prediction, and targeted advertisement). Taking the click-through rate prediction as an example, we can feed the features including the user behaviors (e.g., age, gender, and occupation), advertisement features (e.g., position, brand, device type, and duration) into TEM. We can profile the groups of user why they click the target advertisement.

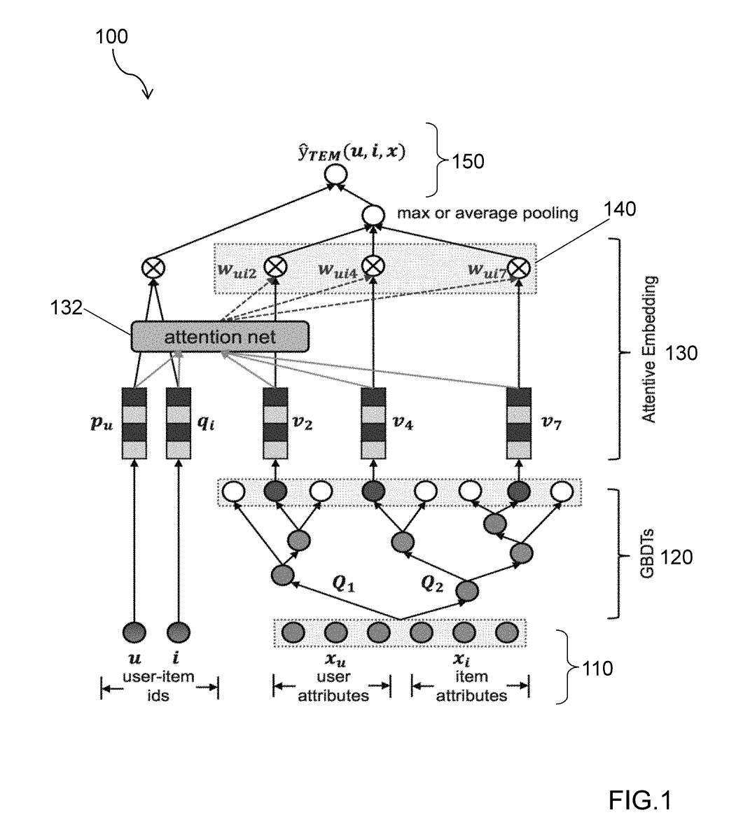

FIG. 1 is a block diagram showing an illustrative architecture of a tree enhanced embedding model according to an embodiment of the present invention. The inputs 110 to the tree enhanced embedding model architecture 100 are a user u, an item i, and their feature vectors [xᵤ, xᵢ]=x∈ [symbol] ⁿ. The feature vectors [xᵤ, xᵢ] indicate attributes of the user u, and the item i, respectively. The feature vectors [xᵤ, xᵢ] are input into a gradient boosting decision tree (GBDT) model 120 to identify cross features which effect the user item preference. The gradient boosting decision tree (GBDT) model 120 is described in more detail below with reference to FIGS. 5A and 5B.

Following the gradient boosting decision tree (GBDT) model 120 there is an attentive embedding layer 130. The gradient boosting decision tree (GBDT) model 120 outputs indications of cross feature vectors which are relevant to the user item preference. These feature vectors are projected onto an embedding vector to obtain a set of cross feature embedding vectors v₂, v₄, v₇. A user embedding vector pᵤ and an item embedding vector qᵢ are also formed and the embedding vectors are input into an attention network 132. The attention network 132 is described in more detail below with reference to FIG. 5. The attention network 132 captures the varying importance of the cross features and generates a set of attentive weights 140 wᵤᵢₗ which are dependent on the user and item under consideration. The output 150 of the tree enhanced embedding model architecture 100 is an indication of a user item preference which is given by:

$${\hat{y}}_{TEM} ( u , i , x ) = {b}_{0} + {\sum }_{t = 1}^{n} {b}_{t} {x}_{t} + {f}_{Θ} ( u , i , x ) ,$$

where the first two terms model the feature biases similar to that of FM, where b₀ is the global bias, bₜ denotes the weight of the t-th feature and f_{Θ}(u, i, x) is the core component of TEM with parameters Θ to model the cross-feature effect. The output 150 may also comprise an indication of one or more of the attentive weights or one or more attentive scores derived from the attentive weights. The attentive weights and the attentive scores indicate the importance of particular cross features in determining the user item preference.

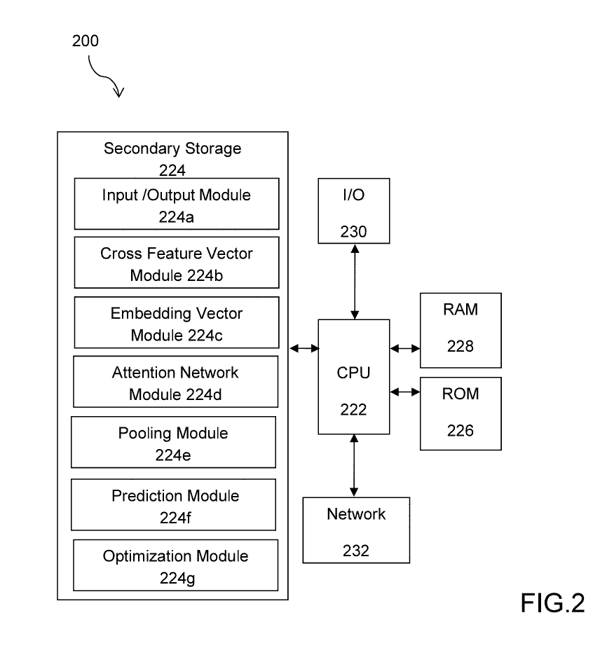

FIG. 2 is a block diagram showing a technical architecture 200 of a data processing system according to an embodiment of the present invention. Typically, the methods of predictive analysis using a tree enhanced embedding model according to embodiments of the present invention are implemented on a computer or a number of computers each having a data-processing unit. The block diagram as shown in FIG. 2 illustrates a technical architecture 200 of a computer which is suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further comprise input/output (I/O) devices 230, and network connectivity devices 232. The technical architecture 200 further comprises activity table storage which may be implemented as a hard disk drive or other type of storage device.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has an input/output module 224a, a cross feature vector module 224b, an embedding vector module 224c, an attention network module 224d, a pooling module 224e, a prediction module 224f and an optimization module 224g comprising non-transitory instructions operative by the processor 222 to perform various operations of the methods of the present disclosure. As depicted in FIG. 2, the modules 224a-224g are distinct modules which perform respective functions implemented by the data processing system. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 224a-224g is described herein, these may alternatively be implemented as one or more hardware modules (such as field-programmable gate array(s) or application-specific integrated circuit(s)) comprising circuitry which implements equivalent functionality to that implemented in software. The ROM 226 is used to store instructions and perhaps data which are read during program execution. The secondary storage 224, the RAM 228, and/or the ROM 226 may be referred to in some contexts as computer readable storage media and/or non-transitory computer readable media.

The I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the method operations described herein. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Although the technical architecture 200 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 200 to provide the functionality of a number of servers that is not directly bound to the number of computers in the technical architecture 200. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

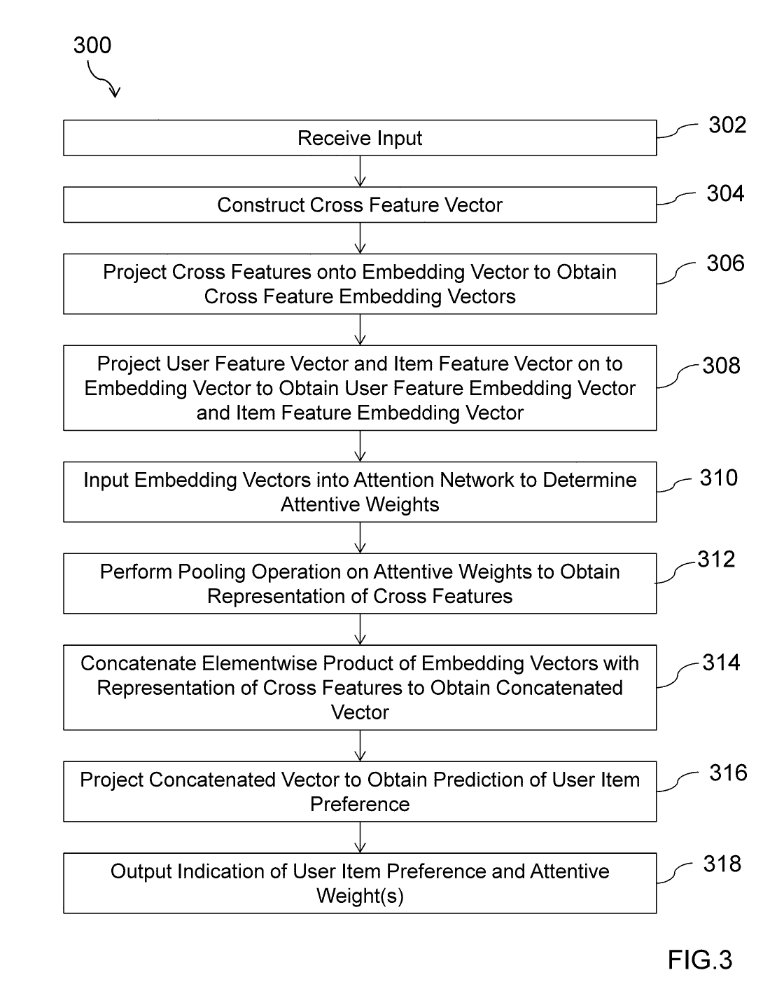

FIG. 3 is a flowchart showing a method of predictive analysis using a tree enhanced embedding model according to an embodiment of the present invention. The method 300 is carried out on the data processing system 200 shown in FIG. 2.

In step 302, the input/output module 224a of the data processing system 200 receives the input 110 comprising an indication of a user it, an item i, and their feature vectors [xᵤ, xᵢ]=x∈ [symbol] ⁿ. The feature vectors [xᵤ, xᵢ] indicate attributes of the user u, and the item i, respectively.

In step 304, the cross feature vector module 224b of the data processing system 200 constructs a cross feature vector q. In constructing the cross feature vector a primary consideration is to make the cross features explicit and explainable.

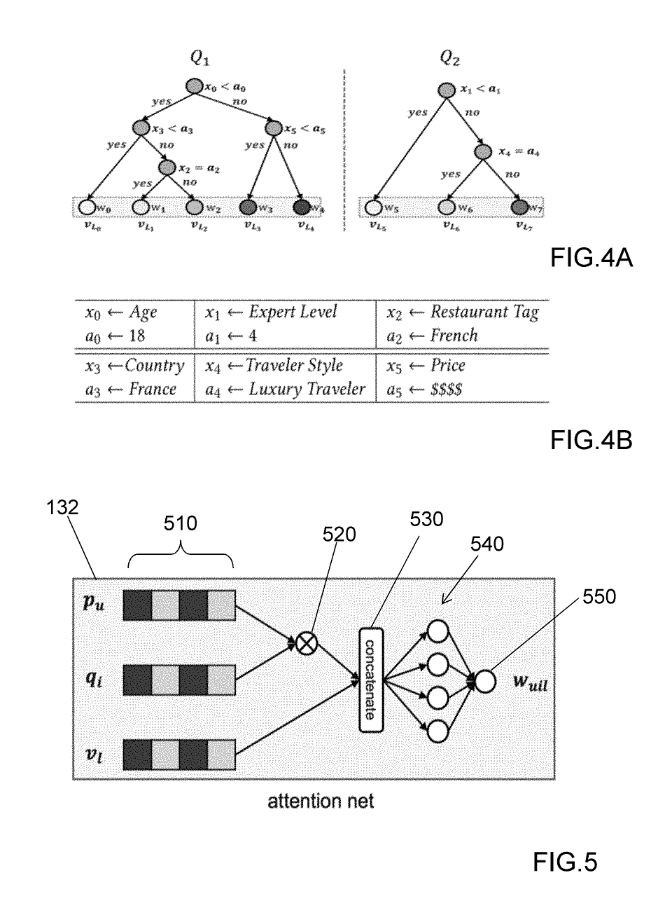

FIG. 4A shows an example gradient boosting decision tree (GBDT) used in an embodiment of the present invention to generate a cross feature vector. FIG. 4B is a table showing example user and item attributes corresponding to the GBDT shown in FIG. 4A. This example relates to a recommendation task of recommending a holiday to a user.

In the example GBDT shown in FIG. 4A, it is possible to cross all values of feature variables age and traveler style to obtain the second-order cross features like [age≥18] & [traveler styles=friends].

As shown in FIG. 4A, we denote a GBDT as a set of decision trees, Q={Q₁, . . . , Q_{S}}, where each tree maps a feature vector x to a leaf node (with a weight); we use Lₛ to denote the number of leaf nodes in the s-th tree.

We represent the cross features as a multi-hot vector q, which is a concatenation of multiple one-hot vectors (where a one-hot vector encodes the activated leaf node of a tree):

q=GBDT(x|Q)=[Q₁(x), . . . ,Q_{S}(x)].

Here q is a sparse vector, where an element of value 1 indicates an activated leaf node and the number of nonzero elements in q is S. Let the size of q be L=Σ_{S}L_{S}. For example, in FIG. 4A, there are two subtrees Q₁ and Q₂ with 5 and 3 leaf nodes, respectively. If x ends up with the second and third leaf node of Q₁ and Q₂, respectively, the resultant multi-hot vector q should be [0, 1, 0, 0, 0, 0, 0, 1]. Let the semantics of feature variables (x₀ to x₅) and values (a₀ to a₅) of FIG. 4A, then q implies the two cross features extracted from x:
(1) υ_{L}_{₁}: [Age<18] & [Country≠France] & [Restaurant Tag=French].
(2) υ_{L}_{₇}: [Expert Level≥4] & [Traveler Style≠Luxury Traveler].

Returning now to FIG. 3, in step 306, the embedding module 224c of the data processing system 200 projects cross features of the cross feature vector onto an embedding vector to obtain a set of cross feature embedding vectors. Given the cross-feature vector q generated by GBDT, we project each cross feature j into an embedding vector vⱼ∈ [symbol] ^{k}, where k is the embedding size. After the operation, we obtain a set of embedding vectors V={q₁v₁, . . . , q_{L}v_{L}}. Since q is a sparse vector with only a few nonzero elements, we only need to include the embeddings of nonzero features for a prediction, i.e., V={vₗ} where qₗ≠0.

In step 308, the embedding vector module 224c of the data processing system 200 projects the user feature vector and the item feature vector on to the embedding vector to obtain a user feature embedding vector and an item feature embedding vector. We use pᵤ and qᵢ to denote the user feature embedding vector and the item feature embedding vector, respectively.

In step 310, the attentive network module 224d of the data processing system 200 inputs the embedding vectors into the attention network 132 to determine attentive weights for each cross feature. wᵤᵢₗ is a trainable parameter denoting the attentive weight of the l-th cross feature in constituting the unified representation, and importantly, it is personalized to be dependent with (u, i).

FIG. 5 shows an example attention network used with embodiments of the present invention. The attention network 132 takes the user feature embedding vector pᵤ, the item feature embedding vector qᵢ and the cross feature embedding vectors vₗ as input into a plurality of layers 510. The product 520 of the output of the layers receiving the user feature embedding vector pᵤ and output of the layers receiving the item feature embedding vector qᵢ is obtained and the resultant product is concatenated 530 with the output of the layers receiving cross feature embedding vectors vₗ. The results 540 of the concatenation are combined to give the attentive weights wᵤᵢₗ as the output 550

We model wᵤᵢₗ as a function dependent on the embeddings of u, i, and l, rather than learning wᵤᵢₗ freely from data. We use a multilayer perceptron (MLP) as the attention network 132 to parameterize wᵤᵢₗ, which is defined as:

$$\{ \begin{matrix}{w}_{uil}^{′} = {h}^{⊤} ReLU ( W ( [ {p}_{u} ⊙ {q}_{i} , {v}_{l} ] ) + b ) \\ {w}_{uil} = \frac{exp ( {w}_{uil}^{′} )}{{\sum }_{( u , i , x ) ∈ O} exp ( {w}_{uil}^{′} )}\end{matrix} ,$$

where W∈ [symbol] ^{a×2k} and b∈ [symbol] ^{a} denote the weight matrix and bias vector of the hidden layer, respectively, and a controls the size of the hidden layer. The vector h∈ [symbol] ^{a} projects the hidden layer into the attentive weight for output. We used the rectifier as the activation function and normalized the attentive weights using softmax. We term a as the attention size.

In step 312, the pooling module 224e of the data processing system 200 aggregates the embeddings of the cross features. Here we consider two ways to aggregate the embeddings of cross features, average pooling and max pooling, to obtain a unified representation e(u, i, V) for cross features:

$$\{ \begin{matrix}{e}_{avg} ( u , i , 𝒱 ) = \frac{1}{\vert 𝒱 \vert} {\sum }_{{v}_{l} ∈ 𝒱} {w}_{uil} {v}_{l} , \\ {e}_{max} ( u , i , 𝒱 ) = {max\_pool}_{{v}_{l} ∈ 𝒱} ( {w}_{uil} {v}_{l} ) ,\end{matrix}$$

The result of the pooling operation is a unified representation of cross features.

In step 314, the prediction module 224f of the data processing system 200 concatenates an elementwise product of the embedding vectors pᵤ and qᵢ with the unified representation of cross features to obtain a concatenated vector. To incorporate the collaborative filtering (CF) modeling, we concatenate e(u, i, V) with pᵤ⊙qᵢ, which reassembles matrix factorization (MF) to model the interaction between user ID and item ID.

In step 316, the prediction module 224f of the data processing system 200 projects the concatenated vector to obtain a prediction of an item user preference. We apply a linear regression to project the concatenated vector to the final prediction. This leads to the predictive model of our TEM as:

$${\hat{y}}_{TEM} ( u , i , x ) = {b}_{0} + {\sum }_{t = 1}^{m} {b}_{t} {x}_{t} + {r}_{1}^{⊤} ( {p}_{u} ⊙ {q}_{i} ) + {r}_{1}^{⊤} e ( u , i , 𝒱 ) ,$$

where r₁∈ [symbol] ^{k} and r₂∈ [symbol] ^{k} are the weights of the final linear regression layer. As can [symbol] be seen, our TEM is a shallow and additive model. To interpret a prediction, we can easily evaluate the contribution of each component. We use TEM-avg and TEM-max to denote the TEM that uses e_{avg}(⋅) and eₘₐₓ(⋅), respectively.

In step 318, the input/output module 224a of the data processing system 200 outputs an indication of the user item preference and an indication of at least one of the attentive weights.

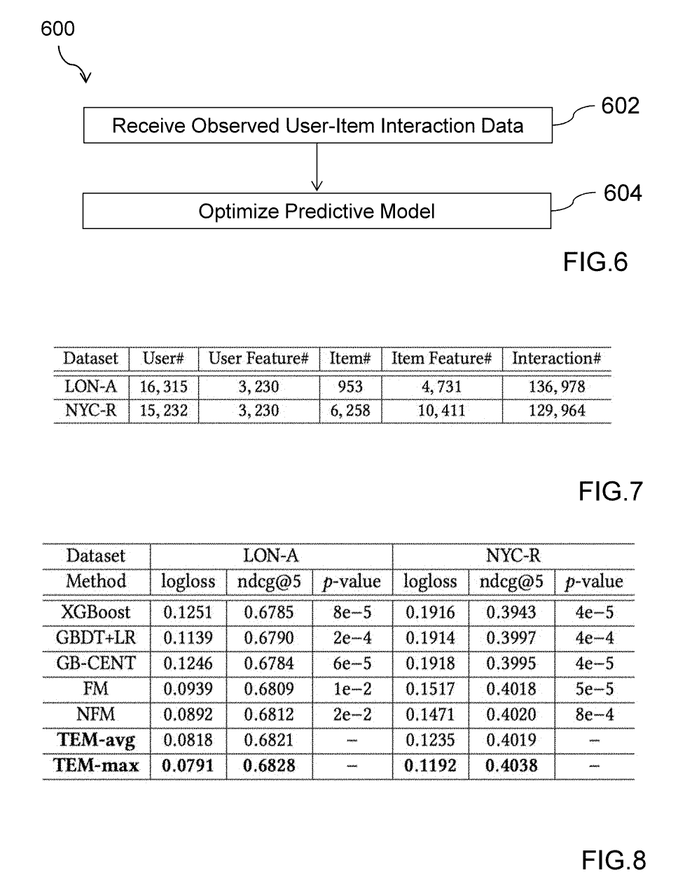

FIG. 6 is a flowchart showing a method of estimating the parameters of a predictive model according to an embodiment of the present invention. The method 600 shown in FIG. 6 is carried out by the data processing system 200 shown in FIG. 2.

In step 602, the input/output module 224a of the data processing system 200 receives observed user-item interaction data.

In step 604, the optimization module 224g of the data processing system optimizes the predictive model. Similar to the recent work on neural collaborative filtering which is described in Xiangnan He, Lizi Liao, Hanwang Zhang, Liqiang Nie, Xia Hu, and Tat-Seng Chua. 2017. Neural Collaborative Filtering. In WWW. 173-182, we solve the item recommendation task as a binary classification problem. Specifically, an observed user-item interaction is assigned to a target value 1, otherwise 0. We optimize the pointwise log loss, which forces the prediction score ŷᵤᵢ to be close to the target yᵤᵢ:

$$ℒ = {\sum }_{( u , i , x ) ∈ O} - {y}_{ui} log σ ( {\hat{y}}_{ui} ) - ( 1 - {y}_{ui} ) log ( 1 - σ ( ( {\hat{y}}_{ui} ) ) ,$$

where σ is the activation function to restrict the prediction to be in (0, 1), set as sigmoid σ(x)=1/(1+e^{-x}) in this disclosure. The regularization terms are omitted here for clarity (we tuned the L 2 regularization in experiments when overfitting was observed). It will be appreciated that other objective functions, such as the pointwise regression loss and ranking loss may also be used in the optimization process. In this example, we use the log loss as a demonstration of our TEM.

The tree enhanced embedding model described above can be used as the generic solution for prediction. We now discuss how to apply TEM to build an e-commerce recommendation system.

In practical E-commerce systems, we typically have three types of data to build a recommendation service: 1) users' interaction histories on products, such as purchasing, rating, clicking histories etc. 2) user profiles, such as demographics like age, gender, hometown, income level etc. 3) product properties, such as categories, prices, descriptive tags, product images etc. For each interaction, we convert it to a training instance with the basic features include user ID and product ID; this will provide the basic collaborative filtering system. To incorporate the side information of user profiles and product properties, we need to do feature engineering based on the types of side information. For categorical variables like ages (male or female) and hometown (Shanghai, Beijing or other cities), we can append them to the feature vector via one-hot encoding.

In the following subsection, we show how to deploy TEM to two recommendation scenarios: tourist attraction recommendation and restaurant recommendation.

We collect data from two populous cities in TripAdvisor: London (LON) and New York City (NYC), and separately perform experiments of tourist attraction and restaurant recommendation.

FIG. 7 is a table showing two datasets used in example recommendation scenarios for embodiments of the present invention. We term the two datasets as LON-A and NYC-R respectively. In particular, we crawl 1,001 tourist attractions (e.g., British Museum) from LON with the corresponding ratings written by 17,238 users from August 2014 to August 2017; similarly, 8,791 restaurants (e.g., The River Cafe) and 16,015 users are obtained from NYC. The ratings are transformed into binary implicit feedback as ground truth, indicating whether the user has interacted with the specific item. To ensure the quality of the data, we retain users/items with at least five ratings only. Moreover, we have collected the natural or system generated labels that are affiliated with users and items as their side information (aka. profile). Particularly, the profile of each user includes gender (e.g., Female), age (e.g., 25-34), and traveler styles (e.g., Foodie and Beach Goer); meanwhile, the side information of an item consists of attributes (e.g., Art Museum and French), tags (e.g., Rosetta Stone and Madelenies), and price (e.g., $$$).

For each dataset, we holdout the latest 20% interaction history of each user to construct the test set, and randomly split the remaining data into training (70%) and validation (10%) sets. The validation set is used to tune hyper-parameters and the final performance comparison is conducted on the test set.

Given one positive user-item interaction in the testing set, we pair it with 50 negative instances that the user did not consume before. Then each method outputs prediction scores for these 51 instances. To evaluate the prediction scores, we adopt two metrics: the error-based log loss and the ranking-aware ndcg@K.

The TEM described in the present disclosure is compared with the following methods:
XGBoost—Tianqi Chen and Carlos Guestrin. 2016. XGBoost: A Scalable Tree Boosting System. In SIGKDD. 785-794: This is the state-of-the-art tree-based method that captures complex feature dependencies.
GBDT+LR—Xinran He, Junfeng Pan, Ou Jin, Tianbing Xu, Bo Liu, Tao Xu, Yanxin Shi, Antoine Atallah, Ralf Herbrich, Stuart Bowers, and Joaquin Quinonero Candela. 2014. Practical Lessons from Predicting Clicks on Ads at Facebook. In ADKDD. 5:1-5:9: This method feeds the cross features extracted from GBDT into the logistic regression, aiming to refine the weights for each cross feature.
GB-CENT—Qian Zhao, Yue Shi, and Liangjie Hong. 2017. GB-CENT: Gradient Boosted Categorical Embedding and Numerical Trees. In WWW. 1311-1319: Such state-of-the-art boosting method combines the prediction results from MF and GBDT. To adjust GB-CENT to perform our tasks, we input the ID features and side information to MF and GBDT, respectively.
FM—Steffen Rendle. 2010. Factorization machines. In ICDM. 995-1000: This is a generic embedding-based model that encodes side information and IDs with embedding vectors. It implicitly models all the second-order cross features via the inner product of any two feature embeddings.
NFM—Xiangnan He and Tat-Seng Chua. 2017. Neural Factorization Machines for Sparse Predictive Analytics. In SIGIR. 355-364: Neural FM is the state-of-the-art factorization model under the neural network framework. It stacks multiple fully connected layers above the inner products of feature embeddings to capture higher-order and nonlinear cross features. Specially, we employed one hidden layers for NFM as suggested in this paper.

For a fair comparison, we optimize all the methods with the same objective function. We implement our proposed TEM using Tensorflow. We use XGBoost to implement the tree-based components of all methods, where the number of trees and the maximum depth of trees is searched in {100, 200, 300, 400, 500} and {3, 4, 5, 6}, respectively. For all embedding-based components, we test the embedding size of {5, 10, 20, 40}, and empirically set the attention size same as the embedding size. All embedding-based methods are optimized using the mini-batch Adagrad for a fair comparison, where the learning rate is searched in {0.005, 0.01, 0.05, 0.1, 0.5}. Moreover, the early stopping strategy is performed, where we stopped training if the logloss on the validation set increased for four successive epoches. Without special mention, we show the results of tree number 500, maximum depth 6, and embedding size 20

FIG. 8 is a table showing a performance comparison of the tree-enhanced embedding method of the present disclosure with other predictive analysis methods. The performance comparison was carried out with respect to logloss and ndcg@5 on LON-A and NYC-R datasets.

We have the following observations:

XGBoost achieves poor performance since it treats sparse IDs as ordinary features and hardly derives useful cross features based on the sparse data. It hence fails to capture the collaborative filtering effect. Moreover, it cannot generalize to unseen feature dependencies. GBDT+LR slightly outperforms XGBoost, verifying the feasibility of treating cross features as the input of one classifier and revising the weight of each cross feature.

The performance of GB-CENT indicates that such boosting may be insufficient to fully facilitate information propagation between two models. Note that to reduce the computational complexity, the modified GB-CENT only conducts GBDT over all the instances, rather than performing GBDT over the supporting instances of each categorical feature. Such modification may contribute to the unsatisfactory performance.

When performing our recommendation tasks, FM and NFM, outperform XGBoost, GBDT+LR, and GB-CENT. It is reasonable since they are good at modeling the sparse interactions and the underlying second-order cross features. NFM benefits from the higher-order and nonlinear feature correlations by leveraging neural networks, thus leads to better performance than FM.

TEM achieves the best performance, substantially outperforming NFM w.r.t. logloss and obtaining a comparable ndcg@5. By integrating the embeddings of cross features, TEM can achieve the comparable expressiveness to NFM. While NFM treats all feature interactions equally, TEM can employ the attention networks on identifying the personalized attention of each cross feature. We further conduct one-sample t-tests to verify that all improvements are statistically significant with p-value<0.05.

To analyze the effect of cross features, we consider the variants that remove cross feature modeling, termed as FM-c, NFM-c, TEM-avg-c, and TEM-max-c. For FM and NFM, one user-item interaction is represented only by the sum of the user and item ID embeddings and their attribute embeddings, without any interactions among features. For TEM, we skip the cross feature extraction and direct feed into the raw features.

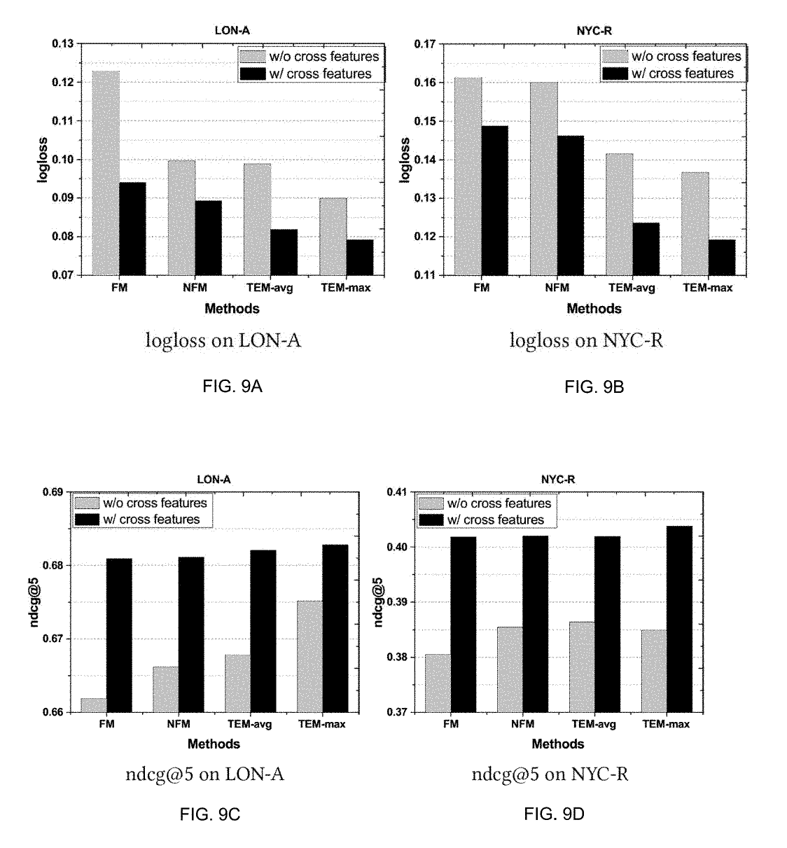

FIGS. 9A to 9D show performance comparisons of the tree enhanced embedding method of the present disclosure with other methods with and without cross feature modelling.

As shown in FIGS. 9A to 9D, we have the following findings:
For all methods, removing cross feature modeling hurts the expressiveness adversely and degrades the recommendation performance. FM-c and NFM-c assume one user/item and her/its attributes are linearly independent, which fail to encode any interactions between them in the embedding space. Taking advantages of the attention network, TEM-avg-c and TEM-max-c still model the interactions between IDs and attributes, and achieve better representation ability than FM-c and NFM-c.

As FIG. 9A and FIG. 9B demonstrate, TEM significantly outperforms FM and NFM by a large margin w.r.t. logloss, verifying the substantial influence of explicit cross feature modeling. While FM and NFM consider all the underlying feature correlations, neither of them explicitly presents the cross features or identifies the importance of each cross feature. This makes them work as a black-box and hurts their explainability. Therefore, the improvement achieved by TEM again verifies the effectiveness of the explicit cross features refined from the tree-based component.

Lastly, while exhibiting the lowest logloss, TEM achieves only comparable performance w.r.t. ndcg@5 to that of NFM, as shown in FIG. 9C and FIG. 9D. It indicates the unsatisfied generalization ability of TEM, since the cross features extracted from GBDT only reflect the feature dependencies observed in the dataset and consequently TEM cannot generalize to the unseen rules.

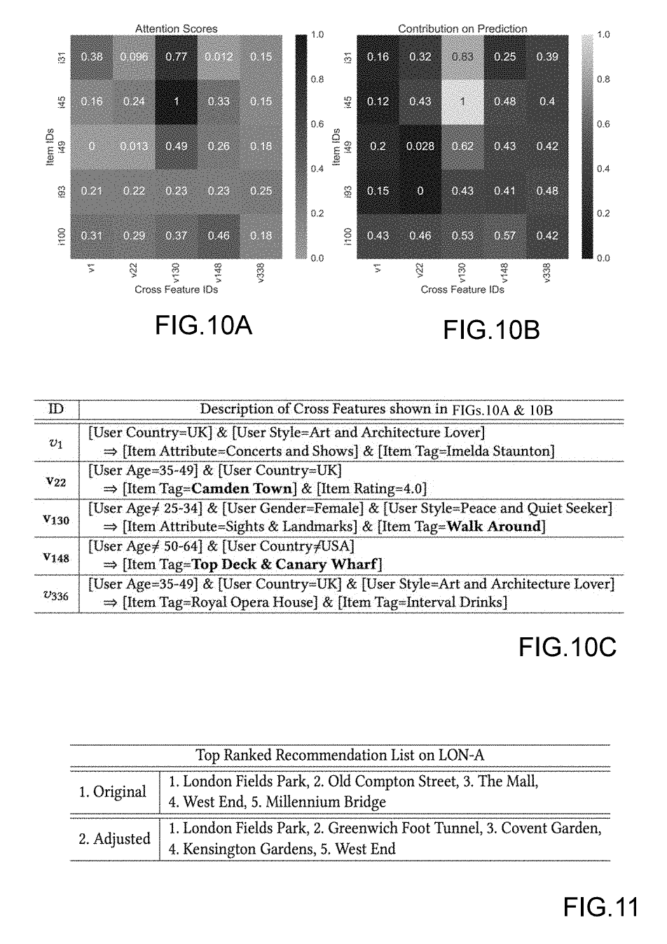

FIG. 10A and FIG. 10B show visualizations of cross feature attention produced by an embodiment of the present invention. The data shown in FIG. 10A and FIG. 10B was produced by TEM-avg on the LON-A dataset described above. FIG. 10A shows a heat map that visualizes the attention value wᵤᵢₗ and FIG. 10B shows its contribution to the final prediction, i.e., wᵤᵢₗr₂^{T}vₗ.

FIG. 10C is a table showing the descriptions of cross features shown in FIG. 10A and FIG. 10B.

To demonstrate the explainability of TEM, we focus on a sampled user, whose profile is {age: 35-49, gender: female, country: the United Kingdom, city: London, expert level: 4, traveler styles: Art and Architecture Lover, Peace and Quite Seeker, Family Vacationer, Urban Explorer}; meanwhile, we randomly select five attractions, {i₃₁: National Theatre, i₄₅: The View form the Shard, i₄₉: The London Eye, i₉₃: Camden Street Art Tours, i₁₀₀: Royal opera House}, from the user's holdout testing set. FIG. 10A and FIG. 10B visualize the learning results, where a row represents an attraction, and a column represents a cross feature (we sample five cross features which are listed in FIG. 10C). The left heat map presents her attention scores over the five sampled cross features and the right displays the contributions of these cross features for the final prediction.

We first focus on the heat map of attention scores in FIG. 10A. Examining the attention scores of a row, we can explain the recommendation for the corresponding attraction using the top cross features. For example, we recommend The View from the Shard (i.e., the second row i₄₅) for the user mainly because of the dominant cross feature v₁₃₀, evidenced by the highest attention score of 1 (cf. the entry at the second row and the third column). Based on the attention scores, we can attribute her preferences on The View from the Shard to her special interests in the item aspects of Walk Around (from v₁₃₀), Top Deck & Canary Wharf (from v₂₂), and Camden Town (from v₁₄₈). To justify the rationality of the reasoning, we further check the user's visiting history, finding that the three item aspects have frequently occurred in her historical items.

In heat map of FIG. 10B, an entry denotes the contribution of the corresponding cross feature (i.e., y′ᵤᵢₗ=wᵤᵢₗr₂^{T}v₁ to the final prediction Jointly analyzing the left and right heat maps, we find that the attention score wᵤᵢₗ is generally consistent with yᵤᵢₗ, which contains useful cues about the user's preference. Based on such outcome, we can utilize the attention scores of cross features to explain a recommendation (e.g., the user prefers i₄₅ owing to the top rules of v₁₃₀ and v₁₄₈ weighted with personalized attention scores of 1 and 0.33). This case demonstrates TEM's capability of providing more informative explanations according to a user's preferred cross features, which we believe are better than mere labels or similar user/item list.

In addition to making the recommendation process transparent, the TEM can further allow a user to correct the process, so as to refresh the recommendation as she desires.

This property of adjusting recommendation is known as the scrutability. As for TEM, the attention scores of cross features serve as a gateway to exert control on the recommendation process.

FIG. 11 shows an example of adjusting recommendation in an embodiment of the present invention. The profile of this user indicates that she enjoys the traveler style of Urban Explorer most; moreover, most attractions in the historical interactions of her are tagged with Sights & Landmarks, Points of Interest and Neighborhoods. Hence, TEM detects such frequent co-occurred cross features and accordingly recommends some attractions like Old Compton Street and The Mall to her. Assuming that the user attempts to scrutinize TEM and would like to visit some attractions tagged with Garden that are suitable for the Nature Lover. Towards this end, we assign the cross features containing [User Style=Nature Lover] & [Item Attribute=Garden] with a higher attentive weight, and then get the predictions of TEM to refresh the recommendations. In the adjusted recommendation list, the Greenwich Foot Tunnel, Covent Garden, and Kensington Gardens are ranked at the top positions. Therefore, based on the transparency and simulated scrutability, we believe that our TEM is easy-to-interpret, explainable and scrutable.

In this disclosure, a tree-enhanced embedding method (TEM), which seamlessly combines the generalization ability of embedding-based models with the explainability of tree-based models was described. Owing to the explicit cross features extracted from tree-based part and the easy-to-interpret attention network, the whole prediction process of our solution is fully transparent and self-explainable. Meanwhile, TEM can achieve comparable performance as the state-of-the-art recommendation methods.

Whilst the foregoing description has described exemplary embodiments, it will be understood by those skilled in the art that many variations of the embodiments can be made within the scope and spirit of the present invention.

1. A predictive analysis method comprising
receiving input data comprising an indication of a user, an indication of an item, a user feature vector indicating features of the user and an item feature vector indicating features of the item;
constructing a cross feature vector indicating values for cross features between features of the user and features of the user;
projecting each cross feature of the cross feature vector onto an embedding vector to obtain a set of cross feature embedding vectors;
projecting the user feature vector onto the embedding vector to obtain a user feature embedding vector and projecting the item feature vector onto the embedding vector to obtain an item feature embedding vector;
inputting the cross feature embedding vectors, the user feature embedding vector and the item feature embedding vector into an attention network to determine a set of attentive weights, the set of attentive weights comprising an attentive weight for each cross feature of the cross feature vector:
performing a pooling operation over the set of attentive weights to obtain a unified representation of cross features;
concatenating an elementwise product of the user embedding vector and the item embedding vector with the unified representation of cross features to obtain a concatenated vector;
projecting the concatenated vector to obtain a prediction of a user item preference; and
outputting an indication of the user item preference.

2. A method according to claim 1, further comprising outputting an indication of at least one attentive weight of the set of attentive weights.

3. A method according to claim 1, further comprising receiving an input indicating an adjustment to the set of attentive weights and adjusting attentive weights of the set of attentive weights in accordance with the adjustment.

4. A method according to claim 1, wherein constructing a cross feature vector comprises using a gradient boosting decision tree.

5. A method according to claim 1, wherein the cross feature vector is a sparse vector.

6. A method according to claim 1, wherein the pooling operation is an average pooling operation.

7. A method according to claim 1, wherein the pooling operation is a max pooling operation.

8. A method according to claim 1, wherein the attentive network is a multilayer perceptron.

9. A computer readable medium carrying processor executable instructions which when executed on a processor cause the processor to carry out a method according to claim 1.

10. A data processing system comprising a processor and a data storage device, the data storage device storing computer executable instructions operable by the processor to:
receive input data comprising an indication of a user, an indication of an item, a user feature vector indicating features of the user and an item feature vector indicating features of the item;
construct a cross feature vector indicating values for cross features between features of the user and features of the user;
project each cross feature of the cross feature vector onto an embedding vector to obtain a set of cross feature embedding vectors;
project the user feature vector onto the embedding vector to obtain a user feature embedding vector and project the item feature vector onto the embedding vector to obtain an item feature embedding vector:
input the cross feature embedding vectors, the user feature embedding vector and the item feature embedding vector into an attention network to determine a set of attentive weights, the set of attentive weights comprising an attentive weight for each cross feature of the cross feature vector;
perform a pooling operation over the set of attentive weights to obtain a unified representation of cross features;
concatenate an elementwise product of the user embedding vector and the item embedding vector with the unified representation of cross features to obtain a concatenated vector;
project the concatenated vector to obtain a prediction of a user item preference; and
output an indication of the user item preference.

11. A data processing system according to claim 10, the data storage device further storing instructions operative by the processor to output an indication of at least one attentive weight of the set of attentive weights.

12. A data processing system according to claim 10, the data storage device further storing instructions operative by the processor to receive an input indicating an adjustment to the set of attentive weights and adjust attentive weights of the set of attentive weights in accordance with the adjustment.

13. A data processing system according to claim 10, the data storage device further storing instructions operative by the processor to construct the cross feature vector using a gradient boosting decision tree.

14. A data processing system according to claim 10, wherein the cross feature vector is a sparse vector.

15. A data processing system according to claim 10, wherein the pooling operation is an average pooling operation.

16. A data processing system according to claim 10, wherein the pooling operation is a max pooling operation.

17. A data processing system according to claim 10, wherein the attentive network is a multilayer perceptron.
